(19) United States
(12) Patent Application Publication
(10) Pub. No.: US 2006/0110284 A1
(43) Pub. Date: May 25, 2006

(54) Paint tester

(76) Inventor: John Gregory Martin, Marietta, GA (US)

Correspondence Address: JOHN G. MARTIN, 171 COUNTY ROAD S/W, MARIETTA, GA, 30064, US

(21) Appl. No.: 10/995,294

(22) Filed: Nov. 24, 2004

(51) Int. Cl. G01N 31/22

(52) U.S. Cl. 422/56

(57) ABSTRACT

The Paint Tester is used to determine if a painted surface is either oil or water base. A double ended pen-like container containing a substance which flows through the fibrous tips at each end of the container. One tip is white or light colored and the other is black or dark colored. Airtight snap on caps are-at each end of container. When a cap is removed from the appropriate colored fibrous tip and the tip rubbed against a painted surface identification will be completed for oil or water base paint NEW: 1. The device is easy to use. Remove the appropriate cap and rub the tip against the paint. No package to open or glass container to crush. 2. The device can be used twice at a minimum. A used tip could be reused for additional testing of contrasting colored paint. 3. The device is fast. Results instantaneous or within 5 seconds.

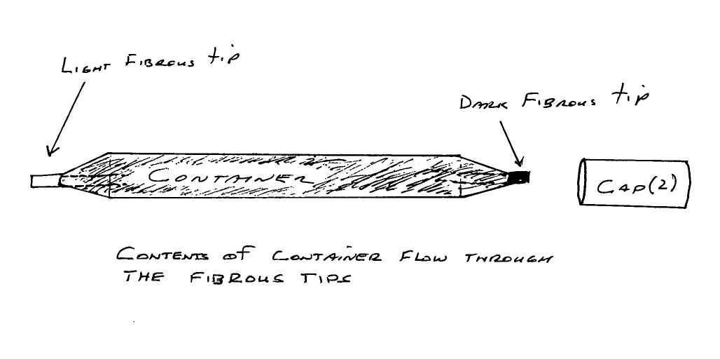

### BACKGROUND OF INVENTION

### Paint Tester

A one step process to determine if a painted surface is either oil or water base. This test is based on the use of a double-ended cylindrical container containing isopropyl alcohol or similar substance that flows through both of the fibrous ends of the container. One fibrous end will be of a light color and the other a dark color. In lieu of a double ended container two separate containers can be used, one with a dark fibrous end and the other with a light fibrous end.

The user only needs to determine if the paint is darker than the light tip and if so, then use the light tip for the test. If the user determines that the paint is lighter than the dark tip, then the dark tip is used for the test. By rubbing the proper tip against the painted surface and viewing the tip the user will always determine if it is water base or oil base paint. Oil base paint will not be affected by the contents of the container however the latex paint will be visable on the fibrous tip. Each end of the container will have an airtight snap on cap, which is removed prior to the test and replaced after the test. The device can be saved and used for other tests.

Current tests use a impregnated material for adhering to the painted surface, which will not identify paint as water base if the color is same as the pad. This invention, using the appropriate light tip or a dark tip, will always identify if the paint is water base. Current tests require adhering the test pad to the painted surface and then wait for up to 15 minutes for the chemical reaction prior to viewing for determination. This test, due to the immediate rubbing of the appropriate saturated tip against the painted surface will have a result in less than 5 seconds.

On other current tests a device is used with only one tip which has two contrasting colors for the test. Only one test can be conducted with this device. This inventor's device can be used twice at a minimum. A used tip could be reused for additional testing of contrasting colored paint.

### History of Related Art

Prior to painting over a painted surface it is very important to determine whether the existing painted surface is a oil base or water base coated surface. The determination will dictate the type of paint to use when re-painting and the method of preparation prior to re-painting. At this time there is no fast 100% reliable method for consumers to use which only require viewing the tip of the fibrous material and permits the device to be used more than one time.

U.S. Pat. No. 5,492,835 discloses a test pad for detecting the type of paint. This method will only allow the paint type determination if it is of a different color than the test pad. Prior art testing methods have not addressed the inability to determine the paint type if it is the same color as the test pad. Additionally, this method requires opening the package and then adhering the pad to the painted surface for a period of up to 15 minutes. Then removing the pad to view the pad or the surface to determine the type of paint.

U.S. Pat. No. 6,214,291 discloses a test device for determining whether paint applied to a surface is oil base or water base paint. This device has only one tip made of two contrasting colors that when saturated with the contents of the container and wiped across the painted surface will indicate if the paint is water base or oil base. This device can only be used once. This device requires that the user crush the enclosed glass vial for the contents to flow through the tip.

### BRIEF SUMMARY OF INVENTION

This invention permits easy and fast determination if a painted surface is of water base or oil base paint. Particularly, due to fact that the fibrous ends of the container are either light or dark, this permits positive identification of a water base paint no matter what the color of the paint. This invention is a reliable, fast, environmentally safe and intended to be a low cost method for a consumer to determine the type of paint. The unused tip can be used at a later time for another test and the used tip can be reused for contrasting painted surfaces.

### DETAILED DESCRIPTION AND DRAWING OF THE INVENTION

As required, detailed embodiments of the present invention are disclosed herein; however it is to be understood that the disclosed embodiments are merely exemplary of the invention, which may be embodied in various forms. Therefore, specific structural and functional details disclosed herein are not to be interpreted as limiting.

Two fibrous tips, one of which is made of light color and the other a dark color are attached to a container or containers so that the contents of the container will flow through the light color tip and the dark color tip. An airtight cap will cover the fibrous tips to minimize evaporation. The container will be hand held size similar to most common writing implements or smaller. The user will use the light color tip for a surface that is darker then the light tip. The user will use the dark color tip for a surface that is lighter than the dark tip. If the surface color is transferred to the tip then it is determined to be a water base painted surface.

1. What I claim as my invention is the using a fibrous material, one of which is light and the other dark, attached to a container(s) filled with an agent in such a manner that the agent will flow through the fibrous material. When the fibrous material is saturated with the agent and the appropriate fibrous tip is rubbed on the surface of a painted surface it will determine if the paint is water or oil based 100% of the time. Additionally the results will be available in less than 5 seconds due to the fact that the saturated fibrous tip is rubbed against the painted surface. Air tight caps will fit over each tip permitting the storage of the device for a later test using the unused tip or a used tip for a contrasting painted surface.
